(19) United States
(12) Patent Application Publication
(10) Pub. No.: US 2015/0291764 A1
(43) Pub. Date: Oct. 15, 2015

(54) ORGANIC-INORGANIC HYBRID SILICA NANOPARTICLE AND METHOD FOR PRODUCING SAME

(71) Applicant: DIC Corporation, Tokyo (JP)

(72) Inventors: Jianjun Yuan, Sakura-shi (JP); Hiroshi Kinoshita, Sakura-shi (JP)

(21) Appl. No.: 14/433,953

(22) PCT Filed: Oct. 10, 2013
(86) PCT No.: PCT/JP2013/077594

§ 371 Date: Apr. 7, 2015

(30) Foreign Application Priority Data
Oct. 10, 2012 (JP) 2012-225044

(51) Int. Cl. C08K 3/36; C08K 3/32

(52) U.S. Cl. CPC C08K 3/36; C08K 3/32; C08K 2003/329

(57) ABSTRACT

Provided are organic-inorganic hybrid silica nanoparticles having excellent monodispersity, an organic component (polymer) being introduced into a silica matrix, the whole of each particle being composed of a hybrid between the organic component and an inorganic component [silica], and the particle diameter being in the range of 5 to 100 nm; and a simple and efficient method for producing the silica nanoparticles. Organic-inorganic hybrid silica nanoparticles contain a copolymer (A) composed of an amorphous polyamine chain and a nonionic polymer chain, an acidic group-containing compound (B), and silica (C). A method for producing organic-inorganic hybrid silica nanoparticles includes the steps of allowing a copolymer (A) composed of an amorphous polyamine chain and a nonionic polymer chain to associate with an acidic group-containing compound (B) in a medium and then performing a sol-gel reaction of a silica source using the association product as a reaction field in the presence of water.

### TECHNICAL FIELD

The present invention relates to organic-inorganic hybrid silica nanoparticles produced by allowing a copolymer composed of an amorphous polyamine and a nonionic polymer chain and an acidic group-containing compound to self-assemble into an association product, and introducing the resulting compound containing the copolymer and the acidic group-containing compound into a silica matrix by a sol-gel reaction using the association product as a template to form the organic-inorganic hybrid silica nanoparticles in which the whole of each particle is organic-inorganic hybridized; and a method for producing the organic-inorganic hybrid silica nanoparticles.

### BACKGROUND ART

Silica nanoparticles have been used in applications, such as fillers for resins and catalysts, and in a wide variety of industrial fields. Regarding such silica nanoparticles, in particular, studies on, for example, the introduction of an organic component and the control of the particle diameter of monodisperse particles have been conducted in order to achieve properties required for various applications.

In applications of hybrid nanoparticles in which an organic component is introduced into silica nanoparticles, the hybrid state of the organic component and silica, the amount of the organic component introduced, the particle diameter and the monodispersity of hybrid particles, and so forth is significantly important factors. As a common method for producing organic-inorganic hybrid silica nanoparticles, for example, organic-inorganic hybrid nanoparticles in which functional organic molecules, a polymer, and so forth are bonded to silica nanoparticles surface-treated with a silane coupling agent are disclosed (for example, see Patent Literatures 1 and 2). However, the hybrid nanoparticles obtained in Patent Literatures 1 and 2 are particles each containing an organic component serving as a shell formed on a surface of silica and are not particles each containing an organic component hybridized with a silica matrix.

In applications of silica nanoparticles to hard coat resin fillers, abrasive fillers, and so forth, monodisperse particles having a spherical shape and a particle diameter of 20 nm or less are required. As a commonly method for producing monodisperse silica nanoparticles, a StÖber method in which the sol-gel reaction of an alkoxysilane is performed in a mixed solution of alcohol, a high concentration of ammonia, and water to form spherical nanoparticles is employed (for example, see NPL 1). Furthermore, for example, a method is disclosed in which when silica nanoparticles are synthesized by the StÖber method, a polyamine is introduced into silica by the addition of a small amount of the polyamine serving as an additive (for example, see PTL 3). However, these methods have difficulty in synthesizing monodisperse spherical silica nanoparticles with a particle diameter of 50 nm or less and have high environmental loads, for example, requirement for a high ammonia concentration in the sol-gel reaction, and low productivity.

In recent years, syntheses of nanosilica that imitates biosilica have been actively performed. Syntheses of silica nanoparticles have been studied in aqueous media using polyamines as templates under mild conditions. For example, syntheses of spherical silica have been studied in aqueous media using polypeptide having polyamine extracted from biosilica, synthetic polyallylamine, a cationic polymer, and so forth (for example, see NPLs 2 to 4). A method for producing monodisperse polyamine-containing silica microparticles by performing a sol-gel reaction using an aggregate composed of a linear polyethyleneimine and a polyfunctional acidic group-containing compound also has been disclosed (for example, see PTL 4).

However, these methods still have difficulty in producing organic-inorganic hybrid silica nanoparticles that can be used as transparent resin fillers and abrasive fillers in a wide variety of fields, the organic-inorganic hybrid silica nanoparticles having good monodispersity and a particle diameter of 50 nm or less. Furthermore, these methods disadvantageously have low production efficiency of silica precipitation because of the poor designs of the templates and so forth. By existing techniques for synthesizing silica nanoparticles, fine organic-inorganic hybrid silica nanoparticles having a uniform particle diameter and containing an organic component hybridized with a silica matrix have never been synthesized, the particle diameter being controlled in the range of 5 to 30 nm, and the whole of each particle being composed of a hybrid between the organic component and silica.

### CITATION LIST

### Patent Literature

PTL 1: Japanese Unexamined Patent Application Publication No. 6-100313
PTL 2: Japanese Unexamined Patent Application Publication (Translation of PCT Application) No. 2010-508391
PTL 3: Japanese Unexamined Patent Application Publication No. 2-263707
PTL 4: Japanese Unexamined Patent Application Publication No. 2006-306711

### Non Patent Literature

NPL 1: W. StÖber et al., J. Colloid Interface Sci., 1968, 26, 62.
NPL 2: D. Morse, Nature, 2000, 403, 289.
NPL 3: N. Kroger, et al., Science, 2002, 298, 584
NPL 4: J. J. Yuan, et al., J. Am. Chem. Soc., 2007, 129, 1717.

### SUMMARY OF INVENTION

### Technical Problem

In light of the foregoing circumstances, the present invention aims to provide organic-inorganic hybrid silica nanoparticles having excellent monodispersity, an organic component (polymer) being introduced into a silica matrix, the whole of each particle being composed of a hybrid of the organic component and an inorganic component [silica], and the particle diameter being in the range of 5 to 100 nm; and a simple and efficient method for producing the silica nanoparticles.

### Solution to Problem

The inventors have conducted intensive studies to overcome the foregoing problems and have found the following: When an acidic functional group-containing compound (B) is added to a copolymer (A) composed of an amorphous polyamine chain and a nonionic polymer chain in a solvent, an association product is readily formed. The association product has a core-shell structure. The core is formed of a complex formed by the interaction between the polyamine and the acidic functional group-containing compound (B). The shell is formed of the nonionic polymer chain in the copolymer (A). The shell layer functions to stabilize the association product in the form of nanoparticles. When a sol-gel reaction is performed using the association product as a template that functions as a catalyst for silica precipitation, the reaction proceeds from the core of the association product. The copolymer is introduced into a silica matrix to provide organic-inorganic hybrid silica nanoparticles having excellent monodispersity, the whole of each particle being composed of a hybrid of the copolymer and silica. These findings have led to the completion of the present invention.

The present invention provides organic-inorganic hybrid silica nanoparticles comprising a copolymer (A) composed of an amorphous polyamine chain and a nonionic polymer chain, an acidic group-containing compound (B), and silica (C); and a simple and efficient method for producing the organic-inorganic hybrid silica nanoparticles.

### Advantageous Effects of Invention

The organic-inorganic hybrid silica nanoparticles produced in the present invention are ultrafine organic-inorganic hybrid silica nanoparticles having excellent monodispersity and a particle diameter of 100 nm or less, particularly, in the range of 5 to 20 nm obtained by the design of the self-assembly of the compound containing the copolymer and the acidic group. Unlike known core-shell silica microparticles, the organic-inorganic hybrid silica nanoparticles of the present invention have a hybrid structure in which the copolymer serving as an organic component is uniformly introduced into a silica matrix at the molecular level. The organic-inorganic hybrid silica nanoparticles have chemical or physical functions derived from the polyamine. For example, the polyamine serves as a strong ligand and thus may concentrate metal ions in the silica. The polyamine also serves as a reductant and thus may reduce concentrated noble metal ions to metal atoms, thereby synthesizing silica-noble metal hybrid nanoparticles. The polyamine is a cationic polymer and has functions, such as sterilization and virus resistance. Thus, the hybrid nanoparticles may also provide these functions. Accordingly, the ultrafine organic-inorganic hybrid silica nanoparticles of the present invention may be used for applications in many fields, such as abrasive fillers, resin fillers, carriers for metal ions, nanometals, or metal oxides, catalysts, fungicides, and cosmetics.

In the production method of the present invention, ultrafine organic-inorganic hybrid silica nanoparticles having excellent monodispersity and the polyamine functions may be produced by a reaction method that imitates silica formation in biological systems under mild conditions, such as a low temperature and a neutral condition, in a short time. The production method results in a low environmental load and a simple production procedure. In addition, it is possible to make a structural design in response to various applications.

The excellent monodispersity is paraphrased into the narrow width of the particle diameter distribution of the nanoparticles and a lower proportion of particles with a particle diameter larger and/or smaller than a target average particle diameter. This should lead to, for example, a technical effect in which problems due to a higher proportion of large particles and a higher proportion of small particles are less likely to occur.

Specifically, for example, in the case where particles are used as hard coat fillers, a higher proportion of large particles results in different light-scattering states and lower transparency, which is not preferred.

In the case where particles are used as a catalyst, a high proportion of large particles results in a small specific surface area, thus possibly reducing the catalytic efficiency. An excessively high proportion of small particles is likely to degrade the storage stability.

### BRIEF DESCRIPTION OF DRAWINGS

FIG. 1 is a transmission electron micrograph of organic-inorganic hybrid silica nanoparticles obtained in Example 1.

FIG. 2 is a transmission electron micrograph of organic-inorganic hybrid silica nanoparticles obtained in Example 2.

FIG. 3 is a transmission electron micrograph of silica nanoparticles obtained in Comparative Example 2.

FIG. 4 is a transmission electron micrograph of branched organic-inorganic hybrid silica nanoparticles obtained in Example 7.

FIG. 5 is a transmission electron micrograph of hollow organic-inorganic hybrid silica nanoparticles obtained in Example 8.

FIG. 6 is a transmission electron micrograph of organic-inorganic hybrid silica nanoparticles obtained in Example 10.

### DESCRIPTION OF EMBODIMENTS

To produce silica (silicon oxide) having a designed nanostructure or shape by a sol-gel reaction in the presence of water, three important conditions are indispensable: (1) a template that directs a shape, (2) a scaffold for the silica sol-gel reaction, and (3) a catalyst that hydrolyzes and polymerizes a silica source.

To satisfy the foregoing three factors, the present invention is characterized by the use of a copolymer (A) composed of an amorphous polyamine chain and a nonionic polymer chain and an acidic group-containing compound (B). When the acidic group-containing compound (B) is added to a solution of the copolymer (A), the polyamine chain in the copolymer (A) interacts with the acidic group-containing compound (B) to form a cross-linked complex. The nonionic polymer chain in the copolymer (A) does not interact with the acidic group-containing compound (B) and is dissolved in a solvent in the form of molecules, thus stabilizing the resulting complex as micellar nanoparticles. As described above, the mixing of the polyamine-containing copolymer (A) with the acidic group-containing compound (B) easily forms a stable association product. Although the structure of the association product remains to be fully elucidated, the association product may have a structure as described below. The association product has a core-shell structure, the core being composed of a complex formed by the interaction between the polyamine and the acidic group-containing compound (B), and the shell layer being composed of the nonionic polymer chain in the copolymer.

The present invention is based on the following findings: The foregoing stable association product is used as a reaction field. The silica source is subjected to the sol-gel reaction due to the catalytic effect of the association product in the solvent, introducing the copolymer (A) into a silica matrix. Thereby, monodisperse ultrafine organic-inorganic hybrid silica nanoparticles in which the copolymer (A) is hybridized with silica (C) in the whole of each particle may be produced.

The term “excellent monodispersity” indicates that, specifically, the width of the particle diameter distribution represented by the following formula (1) is 15% or less.

Width of particle diameter distribution=(standard deviation of particle diameter)×100/average particle diameter(average value of particle diameter) (1)

The terms “average particle diameter” and “standard deviation” of the particles indicate the average value and the standard deviation, respectively, calculated from the diameters of 100 particles measured by electron microscope observation, the particles having been produced under the same conditions.

### [Copolymer (A) Composed of Amorphous Polyamine Chain and Nonionic Polymer Chain]

In the present invention, the polyamine in the copolymer (A) is not particularly limited as long as the polyamine does not crystallize by itself and when the polyamine is present together with the acidic group-containing compound (B), crosslinks are formed by the interaction between the amino group and the acidic group to form a complex (association product). For example, a branched polyethyleneimine chain, a polyallylamine chain, a poly[2-(diisopropylamino)ethyl methacrylate)] chain, a poly[2-(dimethylamino)ethyl methacrylate] chain, and a polyvinylpyridine chain may be used. Of these, the use of the chain soluble in a water-containing medium is preferred because a smaller association product is formed. The branched polyethyleneimine chain is preferably used from the viewpoint of efficiently producing target organic-inorganic hybrid silica nanoparticles. The molecular weight of a polyamine chain portion is not particularly limited as long as a stable association product can be formed by interaction with the acidic group-containing compound (B). The number of repeat units of the polyamine chain is preferably in the range of 5 to 10,000 and particularly preferably 10 to 8,000 from the viewpoint of appropriately forming the association product.

The molecular structure of the polyamine chain portion is not particularly limited and may have a linear, branched, star-like, or comb-like shape. The polyamine chain having a branched structure is preferred from the viewpoint of efficiently forming the association product serving as the template used in the precipitation of silica.

The skeleton of the polyamine chain may be a homopolymer of an amine or a copolymer of two or more amines. A repeat unit other than amine may be present in the skeleton of the polyamine chain as long as the stable association product can be formed by interaction with the acidic group-containing compound (B). In this case, the proportion of the other repeat unit in the skeleton of the polyamine chain is preferably 50% by mole or less, more preferably 30% by mole or less, and most preferably 15% by mole or less in order to appropriately form the association product.

The nonionic polymer chain in the copolymer (A) is not particularly limited as long as it does not interact with amine or the acidic group and is soluble in the solvent for the formation of the association product. For example, in the case where the association product is formed in an aqueous medium, a water-soluble polymer chain composed of polyethylene glycol, polyacrylamide, polyvinylpyrrolidone, or the like may be preferred. In the case where the association product is formed in a hydrophobic organic medium, a hydrophobic polymer chain composed of polyacrylate, polystyrene, or the like may be preferred. To efficiently perform the sol-gel reaction of the silica source, the sol-gel reaction is preferably performed in an aqueous medium. Thus, a polyalkylene glycol chain is preferably used as the nonionic polymer chain. The length of these polymer chains is not particularly limited as long as the association product can be stabilized at the nanoscale. To appropriately form the association product, the number of repeat units of the nonionic polymer chain is preferably 5 to 100,000 and particularly preferably 10 to 10,000.

The bonding state of the polyamine chain to the nonionic polymer chain is not particularly limited as long as it is a stable chemical bond. For example, the nonionic polymer chain may be bonded to an end of the polyamine by coupling or to the skeleton of the polyamine by grafting.

The proportions of the polyamine chain and the nonionic polymer chain in the copolymer (A) are not particularly limited as long as the association product can be formed. To appropriately form the association product, the proportion of the polyamine chain is preferably 5% to 90% by mass, more preferably 10% to 70% by mass, and most preferably 15% to 60% by mass in the copolymer.

### [Acidic Group-Containing Compound (B)]

The acidic group-containing compound (B) used in the present invention may be a compound that can form a physical cross-linked structure (for example, hydrogen bonding) with the amine in the copolymer (A) in the solvent for the formation of the association product to form a stable association product of the acidic group-containing compound (B) and the copolymer (A) composed of the polyamine and the nonionic polymer chain.

For example, a polyfunctional, i.e., di- or higher-functional, acidic compound (b1) may be appropriately used. As the polyfunctional acidic compound (b1), any acidic compound, e.g., an inorganic polyfunctional acidic compound or organic polyfunctional acidic compound, may be used. Examples thereof include di- or higher-functional polyphosphoric acid compounds, di- or higher-functional carboxylic acid compounds, and di- or higher-functional polysulfonic acid compounds.

Specifically, in the case of an inorganic acid, a di- or higher-valent acidic compound may be appropriately used. Examples thereof include phosphoric acid, diphosphoric acid, polyphosphoric acid, sulfuric acid, boric acid, and disulfuric acid.

In the case of an organic acid, examples thereof include aliphatic acids, such as tartaric acid, antimony tartrate, maleic acid, cyclohexanetricarbony acid, cyclohexanehexacarbonyl acid, adamantanedicarboxylic acid, adipic acid, azelaic acid, sebacic acid, undecanedioic acid, di(ethylene glycol)bis(carboxymethyl) ether, and tri(ethylene glycol)bis(carboxymethyl) ether; aromatic and aliphatic sulfonic acids, such as terephthalic acid, biphenyldicarboxylic acid, oxybis(benzoic acid), and PIPES; dyes, such as acid yellow, acid blue, acid red, direct blue, direct yellow, and direct red; polymeric acids, such as poly(acrylic acid), poly(methacrylic acid), and poly(styrene sulfonate); and acidified RNA and DNA oligomers.

In the case where the acidic group-containing compound (B) is a monofunctional acidic compound, the monofunctional acidic compound is preferably a monofunctional acidic compound (b2) having a hydrophobic chain that can be hydrophobically bonded to another chain. In this case, an acidic group is hydrogen-bonded to a nitrogen atom in the polyamine. Hydrophobic chains can gather together by hydrophobic bonding. Thus, a physical crosslink between polyamine moieties is formed in a molecule or between a plurality of molecules, resulting in the association product.

Specific examples of the monofunctional acidic compound (b2) having a hydrophobic chain that can be hydrophobically bonded to another chain include acidic surfactants. For example, a long-chain alkylsulfonic acid, a long-chain alkylcarboxylic acid, or a long-chain alkylphosphoric acid may be used. With respect to the length of the alkyl chain, the alkyl chain preferably has 6 to 22 carbon atoms.

As the acidic group-containing compound (B), nanoparticles (b3) each having a plurality of acidic groups on a surface may be used. The nanoparticles (b3) may be preferably used as long as the size of each of the particles is smaller than that of each of the target silica nanoparticles and the nanoparticles (b3) can form a stable association product with the copolymer (A). The material of the nanoparticles having the plural acidic groups may be a metal, an oxide, or the like.

A compound used as the acidic group-containing compound (B) used in the present invention may be appropriately selected from compounds having various functionalities, thereby introducing any functional molecule into the resulting silica nanoparticles. As the functional molecule used as the acidic group-containing compound (B), in particular, a fluorescent compound is preferably used. In the case where the fluorescent compound is used, the resulting silica nanoparticles also exhibit fluorescence and thus may be appropriately used in various application fields.

Examples of the fluorescent compound include compounds that exhibit strong light emission, such as tetraphenylporphyrin tetracarboxylic acid, pyrenedicarboxylic acids, pyrenedisulfonic acid, pyrenetetrasulfonic acid, tetraphenylporphyrin tetrasulfonic acid, tetraphenylporphyrin tetraphosphonic acid, and phthalocyanine tetrasulfonic acid.

The proportion of the acidic group-containing compound (B) used may be in the range where a stable association product is formed. Regarding the ratio of amine units in the copolymer (A) to acidic groups in the acidic group-containing compound (B), the molar ratio of the amine units to the acidic groups, i.e., amine unit/acidic group, is preferably in the range of 4/1 to 0.1/1, more preferably 2/1 to 0.1/1, and most preferably 0.6/1 to 0.15/1.

### [Organic-Inorganic Hybrid Silica Nanoparticles]

The organic-inorganic hybrid silica nanoparticles of the present invention are nanoparticles in which the polymer is hybridized with silica in the whole of each of the nanoparticles by introducing the copolymer (A) and the acidic group-containing compound (B) into the silica matrix.

The organic-inorganic hybrid silica nanoparticles of the present invention preferably have a particle diameter of 5 to 100 nm. In particular, it is possible to appropriately form ultrafine organic-inorganic hybrid silica nanoparticles having a particle diameter of 5 to 20 nm. The particle diameter of the silica nanoparticles may be adjusted by controlling the preparation conditions of the association product (for example, the type and the length of the polymer chain of the copolymer (A) used, the number and type of the acidic groups of the acidic group-containing compound (B), and the type of the solvent), the type of silica source used, sol-gel reaction conditions, and so forth. The organic-inorganic hybrid silica nanoparticles have outstanding monodispersity. In particular, the particle diameter distribution may have a width of ±15% or less with respect to the average particle diameter.

The organic-inorganic hybrid silica nanoparticles of the present invention basically have a solid sphere shape. A change in synthesis condition allows the nanoparticles to have a branched shape or hollow sphere shape. The shape of the particles may be adjusted by adjusting, for example, the association product and the sol-gel reaction conditions.

The silica content of the organic-inorganic hybrid silica nanoparticles of the present invention varies within a certain range, depending on the reaction conditions and so forth. The organic-inorganic hybrid silica nanoparticles may have a silica content of 30% to 90% by mass and preferably 60% to 90% by mass with respect to the total mass of the organic-inorganic hybrid silica nanoparticles. The silica content may be changed by changing the amount of the polyamine in the copolymer (A), the amount of the association product, and the amount of the silica source used in the sol-gel reaction, and the sol-gel reaction time and temperature.

The organic-inorganic hybrid silica nanoparticles of the present invention contain the nonionic polymer chains, which are used to stabilize the association product, in the surface layers of the nanoparticles. Thus, the polymer chains are basically present on the surfaces of the silica nanoparticles of the present invention. A change in the amount of silica precipitated results in a change in the amount of the nonionic polymer chains present in the surface layers of the silica nanoparticles. That is, the organic-inorganic hybrid silica nanoparticles may be organic-inorganic hybrid silica nanoparticles structurally covered with the nonionic polymer chains (for example, polyethylene glycol).

Regarding the organic-inorganic hybrid silica nanoparticles of the present invention, a sol-gel reaction with an organosilane is performed after the precipitation of silica to modify the organic-inorganic hybrid silica nanoparticles with polysilsesquioxane. Thus, the organic-inorganic hybrid silica nanoparticles of the present invention have excellent monodispersity and high sol stability in a solvent. The organic-inorganic hybrid silica nanoparticles contain polysilsesquioxane and thus can be redispersed in a medium even after calcination at 400° C. or lower or drying to a powder. This is a feature significantly different from the fact that once a known silica nanoparticle dispersion is dried, the nanoparticles cannot be redispersed. In the case of known fine silica particles produced by the StÖber method or the like, it is difficult to perform redispersion in a medium unless surfaces of the resulting fine particles are chemically modified. Furthermore, drying causes secondary aggregation or the like. Thus, pulverization treatment or the like to provide ultrafine nanoscale particles is often needed.

The organic-inorganic hybrid silica nanoparticles of the present invention can concentrate metal ions to a high level and adsorb the metal ions owing to the polyamine chain present in the silica matrix. The polyamine is in a cationic form. Thus, the organic-inorganic hybrid silica nanoparticles of the present invention can also adsorb or immobilize various ionic materials, such as anionic biomaterials. It is also possible to impart an intended function to the nonionic polymer chain in the copolymer (A). It is easy to control the structure of the nonionic polymer chain. It is thus possible to impart various functions thereto.

An example of the function imparted is the immobilization of a fluorescent substance. For example, a polymer on which a small amount of a fluorescent substance, pyrene, porphyrin, or the like is immobilized may be introduced into the polyamine chain to incorporate the functional residues into the silica nanoparticles. In addition, the polyamine chain having a base with which a small amount of a fluorescent dye, e.g., porphyrin, phthalocyanine, or pyrene, containing an acidic group, e.g., a carboxy group or a sulfo group, is mixed may be used to incorporate the fluorescent substance into the nanoparticles.

The organic-inorganic hybrid silica nanoparticles of the present invention may be dried and used as a powder. The powder may be used as a filler for another compound, such as a resin. A dispersion or sol prepared by redispersing the dry powder in a solvent may be mixed with another compound.

### [Method for Producing Organic-Inorganic Hybrid Silica Nanoparticles]

A method for producing organic-inorganic hybrid silica nanoparticles according to the present invention includes a step of forming silica (C) in the presence of the copolymer (A) and the acidic group-containing compound (B). The method may further include, after the formation of silica in the foregoing step, a step of performing a sol-gel reaction of an organosilane to allow the particles to contain polysilsesquioxane.

In the production method of the present invention, the copolymer (A) and the acidic group-containing compound (B) are mixed together in a solvent. This seemingly results in physical crosslinks between the polyamine in the copolymer (A) and the acidic group-containing compound (B) by hydrogen bonding to form a complex. The nonionic polymer chain in the copolymer (A) seemingly stabilizes the resulting complex at the nanoscale to form the stable association product in the solvent.

The solvent used in the formation of the association product is not particularly limited as long as the stable association product is formed. Examples thereof include organic solvents, such as methanol, ethanol, acetonitrile, dimethylformamide, dimethylacetamide, dimethyl sulfoxide, dioxirane, and pyrrolidone. These organic solvents may be used separately or in combination as a mixture. In view of productivity, environment, and cost, alcohol is preferably used, and ethanol is more preferably used.

To precipitate silica, a silica source is added thereto to perform a sol-gel reaction. This reaction needs water, so the association product or the solvent is allowed to contain water. Water may be added at the time of the formation of the association product or after the formation of the association product. In the case where the silica source is a solution or dispersion containing an aqueous medium, the solution or dispersion may be directly added. Regarding the amount of water in the association product solution, the volume ratio of water to other solvent, i.e., (water/other solvent), may be in the range of 5/5 to 0.05/9.95 and preferably 2/8 to 0.1/9.9 from the viewpoint of allowing the sol-gel reaction to proceed satisfactory.

Basically, the concentration of the copolymer (A) at the time of the preparation of the association product may be appropriately set as long as the association products do not coalesce with each other. The concentration is preferably in the range of 0.05% to 15% by mass and more preferably 0.5% to 10% by mass.

The association product of the present invention is formed in the solvent by the simple process on the basis of the physical crosslink between the polyamine and the acid and the stabilization of the complex by the nonionic polymer chain in the copolymer (A). The physical crosslink may be changed into a crosslink due to covalent bonding. A pseudo-association product may also be formed. For example, aldehyde cross-linkers, epoxy cross-linkers, acid chlorides, acid anhydrides, and ester cross-linkers each having two or more functional groups capable of reacting with an amino group of the polyamine at room temperature may be used. Examples of the aldehyde cross-linkers include malonaldehyde, succinaldehyde, glutaraldehyde, adipaldehyde, phthalaldehyde, isophthalaldehyde, and terephthalaldehyde. Examples of the epoxy cross-linkers include polyethylene glycol diglycidyl ether, bisphenol A diglycidyl ether, glycidyl chloride, and glycidyl bromide. Examples of the acid chlorides include malonyl chloride, succinyl chloride, glutaryl chloride, adipoyl chloride, phthaloyl chloride, isophthaloyl chloride, and terephthaloyl chloride. Examples of the acid anhydrides include phthalic anhydride, succinic anhydride, and glutaric anhydride. As the ester cross-linkers, methyl malonate, methyl succinate, methyl glutarate, methyl phthalate, methyl polyethylene glycol carboxylate, and so forth may be used.

The method for producing organic-inorganic hybrid silica nanoparticles of the present invention includes, subsequent to the step of forming the association product, a step of forming silica, i.e., a step of performing a sol-gel reaction of the silica source with the association product serving as a template in the presence of water. Furthermore, after the precipitation of silica, a sol-gel reaction may be performed with an organosilane to allow the organic-inorganic hybrid silica nanoparticles to contain polysilsesquioxane.

Regarding a method for performing the sol-gel reaction, the organic-inorganic hybrid silica nanoparticles may be easily formed by mixing a solution of the association product with the silica source. Examples of the silica source include water glass, tetraalkoxysilanes, and oligomers of tetraalkoxysilanes.

Examples of the tetraalkoxysilanes include tetramethoxysilane, tetraethoxysilane, tetrapropoxysilane, tetrabutoxysilane, and tetra-t-butoxysilane.

Examples of the oligomers of tetraalkoxysilanes include a tetramer of tetramethoxysilane, a heptamer of tetramethoxysilane, a pentamer of tetraethoxysilane, and a decamer of tetraethoxysilane.

The sol-gel reaction that provides the organic-inorganic hybrid silica nanoparticles does not occur in the continuous phase of the solvent and proceeds selectively in the domain of the association product. Thus, any reaction conditions may be used as long as the association product is not dissociated.

In the sol-gel reaction, the amount of the silica source is not particularly limited with respect to the amount of the association product. The ratio of the association product to the silica source may be appropriately set in response to the target composition of the organic-inorganic hybrid silica nanoparticles. In the case where after the precipitation of silica, silica nanoparticles is modified with polysilsesquioxane using the organosilane, the amount of the organosilane is preferably 50% by mass or less and more preferably 30% by mass or less with respect to the amount of the silica source.

Examples of the organosilane that may be used in the modification of the nanoparticles with polysilsesquioxane include alkyltrialkoxysilanes, dialkylalkoxysilanes, and trialkylalkoxysilanes.

Examples of the alkyltrialkoxysilanes include methyltrimethoxysilane, methyltriethoxysilane, ethyltrimethoxysilane, ethyltriethoxysilane, n-propyltrimethoxysilane, n-propyltriethoxysilane, iso-propyltrimethoxysilane, iso-propyltriethoxysilane, 3-chloropropyltrimethoxysilane, 3-chloropropyltriethoxysilane, vinyltrimethoxyasilane, vinyltriethoxysilane, 3-glycydoxypropyltrimethoxysilane, 3-glycydoxypropyltriethoxysilane, 3-aminopropyltrimethoxysilane, 3-aminopropyltriethoxysilane, 3-mercaptopropylmethoxysilane, 3-marcapatotriethoxysilane, 3,3,3-trifluoropropyltrimethoxysilane, 3,3,3-trifluoropropyltriethoxysilane, 3-methacryloxypropyltrimethoxysilane, 3-methacryloxypropyltriethoxysilane, phenyltrimethoxysilane, phenyltriethoxysilane, p-chloromethylphenyltrimethoxysilane, and p-chloromethylphenyltriethoxysilane.

Examples of the dialkylalkoxysilanes include dimethyldimethoxysilane, dimethyldiethoxysilane, and diethyldiethoxysilane.

Examples of the trialkylalkoxysilanes include trimethymethoxysilane and trimethylethoxysilane.

Each of the temperatures of the sol-gel reaction with the silica source and the sol-gel reaction with the organosilane is not particularly limited and may be freely set in the range of 0° C. to 100° C. and preferably 20° C. to 80° C. because of the use of the aqueous medium. To increase the reaction efficiency, the reaction temperature is more preferably set in the range of 50° C. to 70° C.

The sol-gel reaction time with the silica source ranges from 1 minute to several weeks and may be freely selected. In the case of water glass or a methoxysilane, which is an alkoxysilane having high reaction activity, the reaction time may be in the range of 1 minute to 24 hours. To increase the reaction efficiency, the reaction time is preferably set in the range of 30 minutes to 5 hours. In the case of an ethoxysilane or a butoxysilane, which has low reaction activity, the sol-gel reaction time is preferably 5 hours or more and may be about 1 week. The sol-gel reaction time with the organosilane is preferably in the range of 3 hours to 1 week, depending on the reaction temperature.

According to the production method of the present invention, it is possible to produce monodisperse organic-inorganic hybrid silica nanoparticles having a uniform particle diameter without causing aggregation. The particle diameter distribution of the resulting organic-inorganic hybrid silica nanoparticles varies depending on the production conditions and the target particle diameter. It is possible to produce the nanoparticles having a particle diameter distribution in the range of ±15% or less and, under preferred conditions, ±10% or less with respect to the target particle diameter (average particle diameter).

The resulting organic-inorganic hybrid silica nanoparticles, if necessary, may be calcined into silica nanoparticles in which the whole or part of the copolymer (A) is eliminated. The silica nanoparticles having a characteristic nanostructure obtained from the organic-inorganic hybrid silica nanoparticles produced by the production method of the present invention may be used as functional nanoparticles in a wide variety of applications.

As described above, unlike known silica nanoparticles, the production method of the present invention provides the organic-inorganic hybrid silica nanoparticles having excellent monodispersity, the nanoparticles each containing the copolymer (A) and the acidic group-containing compound (B) in the silica matrix and having a particle diameter of 5 to 100 nm. Furthermore, the organic-inorganic hybrid silica nanoparticles containing polysilsesquioxane may be produced and should be applied as a resin filler and an abrasive filler.

The organic-inorganic hybrid silica nanoparticles of the present invention can immobilize and concentrate various substances owing to the polyamine present in the silica matrix. The surfaces of the silica particles may be functionalized by the nonionic polymer chain present in the surface layers. As described above, the organic-inorganic hybrid silica nanoparticles of the present invention can immobilize and concentrate metals and biomaterials in the nanoscale spheres, can be modified with a functional polymer on the particle surfaces, and thus are useful in various fields, such as electronic materials, biotechnology, and environmentally friendly products.

The method for producing silica nanoparticles of the present invention is much easier than widely employed production methods, such as the StÖber method, and provides the ultrafine organic-inorganic hybrid silica nanoparticles that cannot be produced by the StÖber method. Thus, there are high expectations for the applications of the method, irrespective of the industry or field. The nanoparticles are a material useful in both of typical application fields of the silica material and fields to which polyamine is applied.

### EXAMPLES

While the present invention will be described in more detail below by examples, the present invention is not limited to these examples. Unless otherwise specified, the term “%” denotes “% by mass”.

[Observation with Transmission Electron Microscope]

A sol solution of synthesized organic-inorganic hybrid silica nanoparticles was diluted with ethanol and placed on a carbon-coated copper grid. The resulting sample was observed with JEM-2200FS manufactured by JEOL Ltd.

### [Evaluation of Particle Diameter by Small-Angle X-Ray Scattering]

A solution of an association product composed of a copolymer (A) and an acidic group-containing compound (B) or a sol solution of organic-inorganic hybrid silica nanoparticles was measured by small-angle scattering (TTRII, manufactured by Rigaku Corporation). The particle diameter was estimated by NANO-Solver analysis of a scattering curve.

### [Following Sol-Gel Reaction by NMR Measurement]

After a silica source was added to an association product composed of the copolymer (A) and the acidic group-containing compound (B), a DMSO-d6 capillary was inserted into the resulting dispersion, thereby providing a measurement sample. The measurement sample was subjected to ¹H-NMR and ²⁹Si-NMR measurement with JNM-ECA600 manufactured by JEOL Ltd.

### Synthesis of Copolymer Composed of Branched Polyethyleneimine and Polyethylene Glycol Chain

### Synthesis Example 1

A chloroform (30 ml) solution containing 3.8 g (20.0 mmol) of p-toluenesulfonyl chloride was added dropwise to a mixed solution of 20.0 g (4.0 mmol) of a polyethylene glycol (available from Aldrich) having a number-average molecular weight of 5,000, 3.2 g (40.0 mmol) of pyridine, and 20 ml of chloroform over a period of 30 minutes in a nitrogen atmosphere while the mixed solution was stirred and cooled in ice. After the completion of the dropwise addition, the resulting mixture was stirred at a bath temperature of 40° C. for another 4 hours. After the completion of the reaction, 50 ml of chloroform was added thereto to dilute the reaction mixture. Subsequently, the reaction mixture was sequentially washed with 100 ml of 5% hydrochloric acid, 100 ml of a saturated solution of sodium bicarbonate, and 100 ml of saturated brine, dried over magnesium sulfate, filtered, and concentrated under reduced pressure. The resulting solid was washed several times with hexane, filtered, and dried at 80° C. under reduced pressure, thereby providing 20.8 g of a tosylated product.

Next, 20.0 g (3.88 mmol) of the tosylated product synthesized as described above and 6.6 g (0.66 mmol) of a branched polyethyleneimine (manufactured by Nippon Shokubai Co., Ltd.) having an average molecular weight of 10,000, 0.07 g of potassium carbonate, and 100 ml of N,N-dimethylacetamide were stirred at 100° C. for 6 hours in a nitrogen atmosphere. Then 300 ml of a mixed solution of ethyl acetate and hexane (V/V=1/2) was added to the resulting reaction mixture. After the mixture was vigorously stirred at room temperature, the resulting solid product was filtered. The solid was washed twice with 100 ml of a mixed solution of ethyl acetate and hexane (V/V=1/2) and dried under reduced pressure to provide 25.8 g of a copolymer (hereinafter, referred to as “A-1”) in which the polyethylene glycol was bonded to the branched polyethyleneimine.

The synthesized copolymer (A-1) was identified by ¹H-NMR (CDCl₃) measurement (δ (ppm): 3.50 (s), 3.05-2.20 (m)).

### Synthesis of Copolymer Composed of Polyallylamine and Polyethylene Glycol Chain

### Synthesis Example 2

In Synthesis Example 1, 0.44 mol of a polyallyamine (manufactured by Nitto Boseki Co., Ltd.) having an average molecular weight of 15,000 was used in place of the branched polyethyleneimine (manufactured by Nippon Shokubai Co., Ltd.) having an average molecular weight of 10,000, thereby synthesizing a copolymer (hereinafter, referred to as “A-2”). The resulting copolymer (A-2) weighed 25.7 g.

### Synthesis of Organic-Inorganic Hybrid Silica Nanoparticles

### Example 1

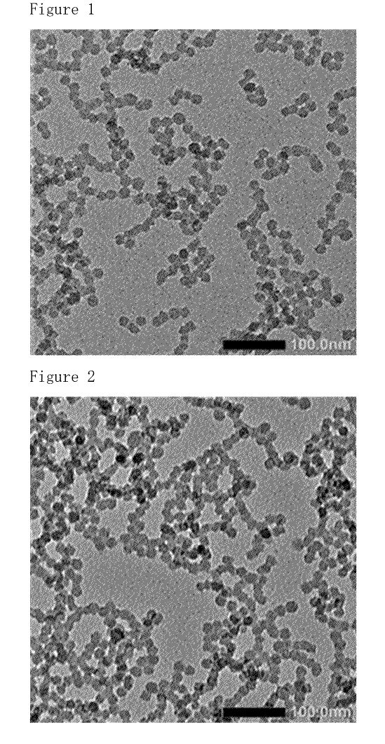

First, 0.1 g of the copolymer (A-1) synthesized in Synthesis Example 1 was dissolved in a solvent mixture of ethanol (4.5 mL) and water (0.5 mL). To the resulting solution of the copolymer (A-1), 0.41 mL of a 10% aqueous solution of phosphoric acid was added, thereby providing an association product composed of the copolymer (A-1) and phosphoric acid. Then 0.50 mL of MS51 (tetramer of methoxysilane) serving as a silica source was added to the dispersion of the association product. The resulting dispersion was allowed to stand at room temperature (20° C. to 30° C.) for 1 week to provide organic-inorganic hybrid silica nanoparticles. The dispersion was a stable sol solution. On the basis of the amounts fed, the silica content of the nanoparticles was estimated at 68% or less, and the solid content of the sol dispersion was estimated at 8.8%. TEM observation demonstrated that the resulting organic-inorganic hybrid silica nanoparticles had a particle diameter of 16 nm or less and were spherical particles having excellent monodispersity (FIG. 1) (the particle diameter distribution had a width of 10% or less).

Small-angle X-ray scattering measurement of the dispersion of the association product composed of the copolymer (A-1) and phosphoric acid, which had been synthesized in Example 1, revealed that the average size was 12.0 nm. In contrast, in the case of a solution of the copolymer (A-1) alone without adding phosphoric acid, no clear scattering peak was observed at about 5 to about 15 nm. This strongly suggests that the copolymer (A-1) and phosphoric acid are allowed to self-assemble into the association product. The organic-inorganic hybrid silica nanoparticles synthesized in Example 1 were also evaluated with small-angle X-ray scattering measurement. The particle diameter was determined by calculation from the scattering of the sample and found to be 17 nm. This is in good agreement with the result of TEM observation.

The sol-gel reaction was followed by NMR measurement. The results demonstrated that the hydrolysis of MS51 was almost completed within 24 hours. This suggests that the polyethyleneimine serving as the core of the association product or the complex composed of the polyethyleneimine and phosphoric acid functions as a catalyst in the sol-gel reaction.

### Example 2

To the dispersion of the association product synthesized in Example 1, 0.50 mL of MS51 serving as a silica source was added. The resulting dispersion was allowed to stand at 60° C. for 6 hours to provide organic-inorganic hybrid silica nanoparticles. The sol-gel reaction was performed at a higher temperature than that in Example 1, thus reducing the synthesis time of the organic-inorganic hybrid silica nanoparticles. TEM observation demonstrated that the resulting organic-inorganic hybrid silica nanoparticles had a particle diameter of 17 nm or less and were spherical particles having excellent monodispersity (FIG. 2) (the particle diameter distribution had a width of 10% or less).

### Comparative Example 1

To a solvent mixture of ethanol (4.5 mL) and water (0.5 mL), 0.5 mL of MS51 was added. After the resulting solution was allowed to stand at room temperature for 48 hours, the precipitation of silica was not observed. The association product which is composed of the copolymer (A) and phosphoric acid and which has the function of catalyzing the sol-gel reaction is not present in the solution; hence, the precipitation of silica does not occur.

### Comparative Example 2

First, 0.1 g of a branched polyethyleneimine (molecular weight: 1,0000, manufactured by Nippon Shokubai Co., Ltd.) was dissolved in a solvent mixture of ethanol (4.5 mL) and water (0.5 mL). To the resulting solution of the branched polyethyleneimine, 0.75 mL of 10% aqueous solution of phosphoric acid was added, thereby providing a white dispersion. To the dispersion, 1.0 mL of MS51 serving as a silica source was added. The resulting dispersion was allowed to stand at room temperature for 48 hours. TEM observation of the resulting sample demonstrated that spherical silica particles having a wide particle diameter range of 50 nm to 300 nm were formed (FIG. 3). This indicates that the complex composed of the polyethyleneimine and phosphoric acid cannot be stabilized at a diameter of 50 nm or less because polyethylene glycol serving as a nonionic polymer chain is not present.

### Comparative Example 3

First, 0.1 g of the copolymer (A-1) synthesized in Synthesis Example 1 was dissolved in a solvent mixture of ethanol (4.5 mL) and water (0.5 mL). To the resulting solution of the copolymer (A-1), 0.50 mL of MS51 serving as a silica source was added. When the resulting dispersion was allowed to stand at room temperature for 30 minutes, the dispersion gelled. The reason for this is presumably that the absence of phosphoric acid fails to form the association product serving as a template for the sol-gel reaction and that the sol-gel reaction proceeds in the entire solution to allow the entire solution to gel without forming nanoparticles.

### Example 3

First, 0.1 g of the copolymer (A-2) obtained in Synthesis Example 2 was dissolved in a solvent mixture of ethanol (4.5 mL) and water (0.5 mL). The pH of the resulting solution of the copolymer (A-2) was adjusted near neutral pH with a 10% aqueous solution of phosphoric acid to provide an association product of the copolymer (A-2) and phosphoric acid. To the dispersion of the association product, 0.50 mL of MS51 serving as a silica source was added. The resulting dispersion was allowed to stand at room temperature for 1 week to provide organic-inorganic hybrid silica nanoparticles. TEM observation demonstrated that the organic-inorganic hybrid silica nanoparticles had a particle diameter of several tens of nanometers to 30 nm and were spherical particles having excellent monodispersity (the particle diameter distribution had a width of 10% or less).

### Synthesis of Organic-Inorganic Hybrid Silica Nanoparticles Containing Polysilsesquioxane

### Example 4

To the dispersion of the association product synthesized in Example 1, 0.50 mL of MS51 serving as a silica source was added. After the resulting dispersion was allowed to stand at room temperature for 24 hours, 50 μL of trimethylmethoxysilane was added thereto. The dispersion was allowed to stand at room temperature for another 1 week, thereby providing organic-inorganic hybrid silica nanoparticles containing polysilsesquioxane. TEM observation demonstrated that the resulting organic-inorganic hybrid silica nanoparticles had a particle diameter of 14 to 15 nm and were spherical particles having excellent monodispersity (the particle diameter distribution had a width of 10% or less). The sol stability of the resulting organic-inorganic hybrid silica nanoparticles modified with polysilsesquioxane was evaluated in an ethanol solvent and found that the sol solution (solid content: 9.6%) exhibited high sol stability without causing gelation, aggregation, or sedimentation even after 3 months. This indicates that polysilsesquioxane contained in the nanoparticles inhibited the gelation of the organic-inorganic hybrid silica nanoparticles.

### Example 5

To the dispersion of the association product synthesized in Example 1, 0.50 mL of MS51 serving as a silica source was added. After the resulting dispersion was allowed to stand at 35° C. for 4 hours, 50 μL of trimethylmethoxysilane was added. The resulting dispersion was allowed to stand at 60° C. for another 24 hours, thereby providing organic-inorganic hybrid silica nanoparticles containing polysilsesquioxane. The sol-gel reaction was performed at a higher temperature than that in Example 3 thus reducing the synthesis time of the organic-inorganic hybrid silica nanoparticles. TEM observation demonstrated that the resulting organic-inorganic hybrid silica nanoparticles had a particle diameter of 12 to 14 nm and were spherical particles having excellent monodispersity (the particle diameter distribution had a width of 10% or less).

### Synthesis of Branched Organic-Inorganic Hybrid Silica Nanoparticles Containing Polysilsesquioxane

### Example 6

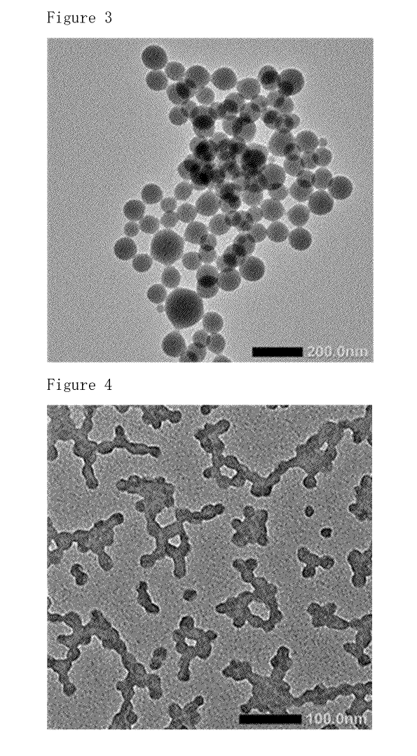

First, 0.1 g of the copolymer (A-1) obtained in Synthesis Example 1 was dissolved in a solvent mixture of ethanol (4.5 mL) and water (0.5 mL). To the resulting solution of the copolymer (A-1), 0.82 mL of a 10% aqueous solution of phosphoric acid was added, thereby providing an association product composed of the copolymer (A-1) and phosphoric acid. Then 0.25 mL of MS51 serving as a silica source was added to the dispersion of the association product. After the resulting dispersion was allowed to stand at 35° C. for 4 hours, 100 μL of trimethylmethoxysilane was added thereto. The dispersion was allowed to stand at 35° C. for another 24 hours, thereby providing organic-inorganic hybrid silica nanoparticles containing polysilsesquioxane. On the basis of the amounts fed, the silica content of the nanoparticles was estimated at 36% or less, and the solid content of the sol dispersion was estimated at 8.4% or less. TEM observation demonstrated that the resulting organic-inorganic hybrid silica nanoparticles had a branched shape and that the network had a thickness of 20 to 60 nm (FIG. 4). A reduction in the molar ratio of ethyleneimine to phosphoric acid and a reduction in the amount of the silica source used resulted in the formation of the branched organic-inorganic hybrid silica nanoparticles.

### Synthesis of Hollow Organic-Inorganic Hybrid Silica Nanoparticles Containing Polysilsesquioxane

### Example 7

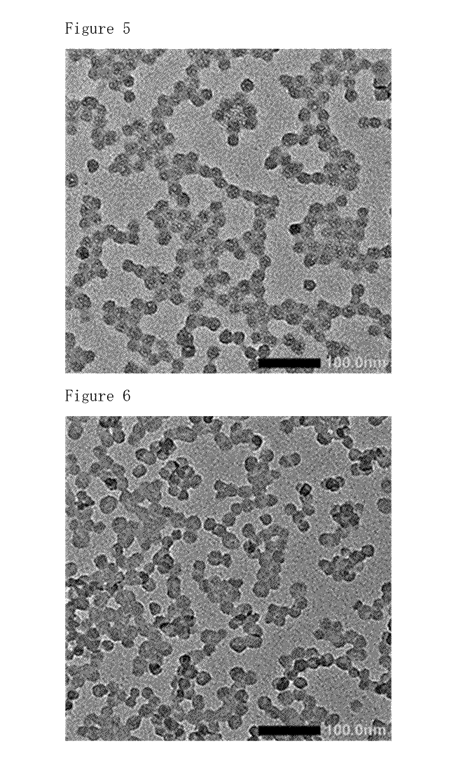

First, 0.1 g of the copolymer (A-1) synthesized in Synthesis Example 1 was dissolved in a solvent mixture of ethanol (4.5 mL) and water (0.5 mL). To the resulting solution of the copolymer (A-1), 1.2 mL of a 10% aqueous solution of phosphoric acid was added, thereby providing an association product composed of the copolymer (A-1) and phosphoric acid. Then 1.0 mL of MS51 serving as a silica source was added to the dispersion of the association product. After the resulting dispersion was allowed to stand at 35° C. for 4 hours, 400 μL of trimethylmethoxysilane was added thereto. The dispersion was allowed to stand at 60° C. for another 24 hours, thereby providing organic-inorganic hybrid silica nanoparticles containing polysilsesquioxane. On the basis of the amounts fed, the silica content of the nanoparticles was estimated at 50% or less, and the solid content of the sol dispersion was estimated at 24% or less. TEM observation demonstrated that the resulting organic-inorganic hybrid silica nanoparticles had a particle diameter of 18 to 22 nm and were monodisperse hollow spherical particles (FIG. 5) (the particle diameter distribution had a width of 10% or less).

### Example 8

To the dispersion of the association product synthesized in Example 1, 1.0 mL of MS51 serving as a silica source was added. After the resulting dispersion was allowed to stand at 35° C. for 4 hours, 400 μL of trimethylmethoxysilane was added. The resulting dispersion was allowed to stand at 60° C. for another 24 hours, thereby providing organic-inorganic hybrid silica nanoparticles containing polysilsesquioxane. On the basis of the amounts fed, the silica content of the nanoparticles was estimated at 51% or less, and the solid content of the sol dispersion was estimated at 24% or less. TEM observation demonstrated that the resulting organic-inorganic hybrid silica nanoparticles had a particle diameter of 17 to 20 nm and were spherical particles having excellent monodispersity (the particle diameter distribution had a width of 10% or less).

### Example 9

To the dispersion of the association product synthesized in Example 1, 0.25 mL of MS51 serving as a silica source was added. After the resulting dispersion was allowed to stand at 35° C. for 4 hours, 100 μL of trimethylmethoxysilane was added. The resulting dispersion was allowed to stand at 60° C. for another 24 hours, thereby providing organic-inorganic hybrid silica nanoparticles containing polysilsesquioxane. On the basis of the amounts fed, the silica content of the nanoparticles was estimated at 32% or less, and the solid content of the sol dispersion was estimated at 9.4% or less. TEM observation demonstrated that the resulting organic-inorganic hybrid silica nanoparticles had a particle diameter of 20 to 30 nm and were spherical particles having excellent monodispersity (FIG. 6) (the particle diameter distribution had a width of 10% or less).

### Example 10

First, 0.05 g of the copolymer (A-1) synthesized in Synthesis Example 1 was dissolved in a solvent mixture of ethanol (4.7 mL) and water (0.3 mL). The pH of the resulting solution of the copolymer (A-1) was adjusted to 7.0 with a 10% aqueous solution of phosphoric acid to provide an association product of the copolymer (A-1) and phosphoric acid. To the dispersion of the association product, 0.125 mL of MS51 serving as a silica source was added. After the resulting dispersion was allowed to stand at 35° C. for 4 hours, 50 μL of trimethylmethoxysilane was added. The resulting dispersion was allowed to stand at 60° C. for another 24 hours, thereby providing organic-inorganic hybrid silica nanoparticles containing polysilsesquioxane. TEM observation demonstrated that the resulting organic-inorganic hybrid silica nanoparticles had a particle diameter of 9 to 11 nm and were spherical particles having excellent monodispersity (the particle diameter distribution had a width of 10% or less).

### Example 11

First, 0.2 g of the copolymer (A-1) synthesized in Synthesis Example 1 was dissolved in a solvent mixture of ethanol (4.7 mL) and water (0.3 mL) (concentration of the copolymer (A-1): 4%). The pH of the resulting solution of the copolymer (A-1) was adjusted to 7.0 with a 10% aqueous solution of phosphoric acid to provide an association product of the copolymer (A-1) and phosphoric acid. To the dispersion of the association product, 0.5 mL of MS51 serving as a silica source was added. After the resulting dispersion was allowed to stand at 35° C. for 4 hours, 200 μl, of trimethylmethoxysilane was added. The resulting dispersion was allowed to stand at 60° C. for another 48 hours, thereby providing organic-inorganic hybrid silica nanoparticles containing polysilsesquioxane. TEM observation demonstrated that the resulting organic-inorganic hybrid silica nanoparticles had a particle diameter of 10 to 13 nm and were spherical particles having excellent monodispersity (the particle diameter distribution had a width of 10% or less).

1. Organic-inorganic hybrid silica nanoparticles comprising a copolymer (A) composed of an amorphous polyamine chain and a nonionic polymer chain, an acidic group-containing compound (B), and silica (C).

2. The organic-inorganic hybrid silica nanoparticles according to claim 1, wherein the copolymer (A) is hybridized with a matrix of silica (C).

3. The organic-inorganic hybrid silica nanoparticles according to claim 1, further comprising polysilsesquioxane (D).

4. The organic-inorganic hybrid silica nanoparticles according to claim 1, wherein the amorphous polyamine chain is a branched polyethyleneimine chain.

5. The organic-inorganic hybrid silica nanoparticles according to claim 1, wherein the organic-inorganic hybrid silica nanoparticles have an average particle diameter of 5 to 100 nm and monodispersity.

6. A dispersion comprising the organic-inorganic hybrid silica nanoparticles according to claim 1.

7. A method for producing organic-inorganic hybrid silica nanoparticles, comprising the steps of allowing a copolymer (A) composed of an amorphous polyamine chain and a nonionic polymer chain to associate with an acidic group-containing compound (B) in a medium and then performing a sol-gel reaction of a silica source using the association product as a reaction field in the presence of water.

8. The method for producing organic-inorganic hybrid silica nanoparticles according to claim 7, further comprising a step of performing a sol-gel reaction of an organosilane.

9. A method for producing a dispersion containing organic-inorganic hybrid silica nanoparticles, comprising the steps of allowing a copolymer (A) composed of an amorphous polyamine chain and a nonionic polymer chain to associate with an acidic group-containing compound (B) in a medium and then performing a sol-gel reaction of a silica source using the association product as a reaction field in the presence of water.

10. The method for producing a dispersion containing organic-inorganic hybrid silica nanoparticles according to claim 9, further comprising a step of performing a sol-gel reaction of an organosilane.

11. The organic-inorganic hybrid silica nanoparticles according to claim 2, further comprising polysilsesquioxane (D).

12. The organic-inorganic hybrid silica nanoparticles according to claim 2, wherein the amorphous polyamine chain is a branched polyethyleneimine chain.

13. The organic-inorganic hybrid silica nanoparticles according to claim 3, wherein the amorphous polyamine chain is a branched polyethyleneimine chain.

14. The organic-inorganic hybrid silica nanoparticles according to claim 2, wherein the organic-inorganic hybrid silica nanoparticles have an average particle diameter of 5 to 100 nm and monodispersity.

15. The organic-inorganic hybrid silica nanoparticles according to claim 3, wherein the organic-inorganic hybrid silica nanoparticles have an average particle diameter of 5 to 100 nm and monodispersity.

16. The organic-inorganic hybrid silica nanoparticles according to claim 4, wherein the organic-inorganic hybrid silica nanoparticles have an average particle diameter of 5 to 100 nm and monodispersity.

17. A dispersion comprising the organic-inorganic hybrid silica nanoparticles according to claim 2.

18. A dispersion comprising the organic-inorganic hybrid silica nanoparticles according to claim 3.

19. A dispersion comprising the organic-inorganic hybrid silica nanoparticles according to claim 4.

20. A dispersion comprising the organic-inorganic hybrid silica nanoparticles according to claim 5.
